(19) United States
(12) Patent Application Publication
(10) Pub. No.: US 2013/0050628 A1
(43) Pub. Date: Feb. 28, 2013

(54) LIQUID CRYSTAL DISPLAY APPARATUS

(71) Applicants: Keisuke Takano, Saitama-shi (JP); Nobuko Fukuoka, Saitama-shi (JP); Arihiro Takeda, Saitama-shi (JP)

(72) Inventors: Keisuke Takano, Saitama-shi (JP); Nobuko Fukuoka, Saitama-shi (JP); Arihiro Takeda, Saitama-shi (JP)

(21) Appl. No.: 13/585,468

(22) Filed: Aug. 14, 2012

(30) Foreign Application Priority Data
Aug. 24, 2011 (JP) 2011-182897

(51) Int. Cl. G02F 1/1343

(52) U.S. Cl. 349/143

(57) ABSTRACT

According to one embodiment, a liquid crystal display apparatus includes a liquid crystal display panel, a sensing substrate, and an adhesive. The liquid crystal display panel includes a first substrate including a pixel electrode, a second substrate, a liquid crystal layer and a pixel. The pixel electrode includes a primary pixel electrode. The common electrode includes a pair of primary common electrodes. The sensing substrate is configured to detect positional information of a location input. The adhesive joins the liquid crystal display panel and the sensing substrate.

### CROSS-REFERENCE TO RELATED APPLICATIONS

This application is based upon and claims the benefit of priority from Japanese Patent Application No. 2011-182897, filed Aug. 24, 2011, the entire contents of which are incorporated herein by reference.

### FIELD

Embodiments described herein relate generally to a liquid crystal display apparatus.

### BACKGROUND

A liquid crystal display apparatus as a flat-type display apparatus is used for various uses such as a large-screen TV, a personal computer (PC), factory automation (FA), an office automation (OA) device, a car navigation system, a cellular phone, a smartphone, and a tablet computer. The multi-domain vertical alignment (MVA) and fringe field switching (FFS) modes have been developed as display modes of a liquid crystal display apparatus to improve display performance of the liquid crystal display apparatus.

A high-contrast uniform display over a large screen is more easily obtainable from a liquid crystal display apparatus in MVA mode than a liquid crystal display apparatus in FFS mode and has a relatively high transmittance. Thus, a liquid crystal display apparatus in MVA mode is widely used ranging from a large-screen TV to small mobile use such as on a mobile phone.

A liquid crystal display apparatus includes a liquid crystal display panel, a sensing substrate, and a protection board. To join the liquid crystal display panel and the sensing substrate, and the sensing substrate and the protection board, instead of the air gap method that degrades the appearance because of reflection, the adoption of the screen fit method is discussed. Between the liquid crystal display panel and the sensing substrate, for example, while a layer of air exists according to the air gap method, an adhesive is interposed according to the screen fit method.

### BRIEF DESCRIPTION OF THE DRAWINGS

FIG. 1 is an exploded perspective view schematically showing a liquid crystal display apparatus according to an embodiment;

FIG. 2 is a sectional view schematically showing the liquid crystal display apparatus;

FIG. 3 is a diagram showing a state in which the liquid crystal display apparatus is pressed by an input means;

FIG. 4 is a diagram schematically showing a configuration and an equivalent circuit of a liquid crystal display panel of the liquid crystal display apparatus;

FIG. 5 is a plan view schematically showing a structure example of one pixel when the liquid crystal display panel is viewed from a countersubstrate side;

FIG. 6 is a sectional view of the liquid crystal display panel schematically showing a section structure when cut along line VI-VI in FIG. 5;

FIG. 7 is a diagram illustrating an electric field formed between a pixel electrode and a common electrode in the liquid crystal display panel shown in FIG. 5 and a relationship between a director of liquid crystal molecules by the electric field and transmittance;

FIG. 8 is an enlarged plan view showing a portion of a sensing substrate shown in FIGS. 1 to 3;

FIG. 9 is a sectional view showing a portion of the sensing substrate along line IX-IX in FIG. 8;

FIG. 10 is a plan view schematically showing another structure example of one pixel when the liquid crystal display panel shown in FIG. 4 is viewed from the countersubstrate side;

FIG. 11 is a plan view schematically showing still another structure example of one pixel when the liquid crystal display panel shown in FIG. 4 is viewed from the countersubstrate side;

FIG. 12 is a plan view schematically showing still another structure example of one pixel when the liquid crystal display panel shown in FIG. 4 is viewed from the countersubstrate side; and

FIG. 13 is a plan view schematically showing still another structure example of one pixel when the liquid crystal display panel shown in FIG. 4 is viewed from the countersubstrate side.

### DETAILED DESCRIPTION

In general, according to one embodiment, there is provided a liquid crystal display apparatus comprising: a liquid crystal display panel; a sensing substrate; and an adhesive. The liquid crystal display panel includes a first substrate having a pixel electrode, a second substrate including a common electrode, a liquid crystal layer held between the first substrate and the second substrate, a display area opposing with the first substrate, the second substrate and the liquid crystal layer, and a pixel provided in the display area, whose length in a first direction is shorter than length in a second direction orthogonal to the first direction, and formed of the pixel electrode and the common electrode. The pixel electrode includes a primary pixel electrode including a major axis in the second direction. The common electrode includes a pair of primary common electrodes positioned to sandwich the primary pixel electrode in the first direction and including a major axis in the second direction. The sensing substrate comprises an input area opposing the display area and configured to detect positional information of a location input into the input area. The adhesive is opposed to the display area and the input area and positioned between the liquid crystal display panel and the sensing substrate to join the liquid crystal display panel and the sensing substrate.

According to another embodiment, there is provided a liquid crystal display apparatus comprising: a liquid crystal display panel; a sensing substrate; and an adhesive. The liquid crystal display panel includes a first substrate having a pixel electrode, a second substrate including a common electrode, a liquid crystal layer held between the first substrate and the second substrate, a display area opposing with the first substrate, the second substrate and the liquid crystal layer, and a pixel provided in the display area, whose length in a first direction is shorter than length in a second direction orthogonal to the first direction, and formed of the pixel electrode and the common electrode. The pixel electrode includes a primary pixel electrode including a major axis in the second direction. The common electrode includes a pair of primary common electrodes positioned to sandwich the primary pixel electrode in the first direction and including a major axis in the second direction. The sensing substrate comprises an input area opposing the display area and configured to detect positional information of a location input into the input area. The adhesive is opposed to the display area and the input area and positioned between the liquid crystal display panel and the sensing substrate to join the liquid crystal display panel and the sensing substrate. The liquid crystal layer includes negative dielectric anisotropy. The pixel electrode includes a secondary pixel electrode formed by extending in the first direction. The common electrode includes a pair of secondary common electrodes positioned to sandwich the secondary pixel electrode in the second direction and formed by extending in the first direction.

According to another embodiment, there is provided a liquid crystal display apparatus comprising: a liquid crystal display panel; a sensing substrate; a first adhesive; a protection board; and a second adhesive. The liquid crystal display panel includes a first substrate including a pixel electrode including a primary pixel electrode and a secondary pixel electrode orthogonal to and connected to the primary pixel electrode and a first alignment film covering the pixel electrode and initially treated for alignment in parallel with the primary pixel electrode, a second substrate including a common electrode including a primary common electrode arranged in parallel with the primary pixel electrode and a secondary common electrode orthogonal to and connected to the primary common electrode and a second alignment film covering the common electrode and initially treated for alignment in parallel with the primary common electrode, and a liquid crystal layer held between the first substrate and the second substrate, including liquid crystal molecules of positive dielectric anisotropy, and including a cell gap smaller than an interval between the primary pixel electrode and the primary common electrode. The sensing substrate includes an input area opposing a display area opposing with the first substrate, the second substrate and the liquid crystal layer configured to detect positional information of a location input into the input area. The first adhesive is opposed to the display area and the input area and positioned between the liquid crystal display panel and the sensing substrate to join the liquid crystal display panel and the sensing substrate. The protection board is opposed to the sensing board. The second adhesive is opposed to the display area and the input area and positioned between the sensing substrate and the protection board to join the sensing substrate and the protection board.

A liquid crystal display apparatus according to an embodiment will be described in detail below with reference to the drawings. In each diagram, the same reference numerals are attached to structural elements achieving the same function or similar functions and overlapping descriptions will be omitted.

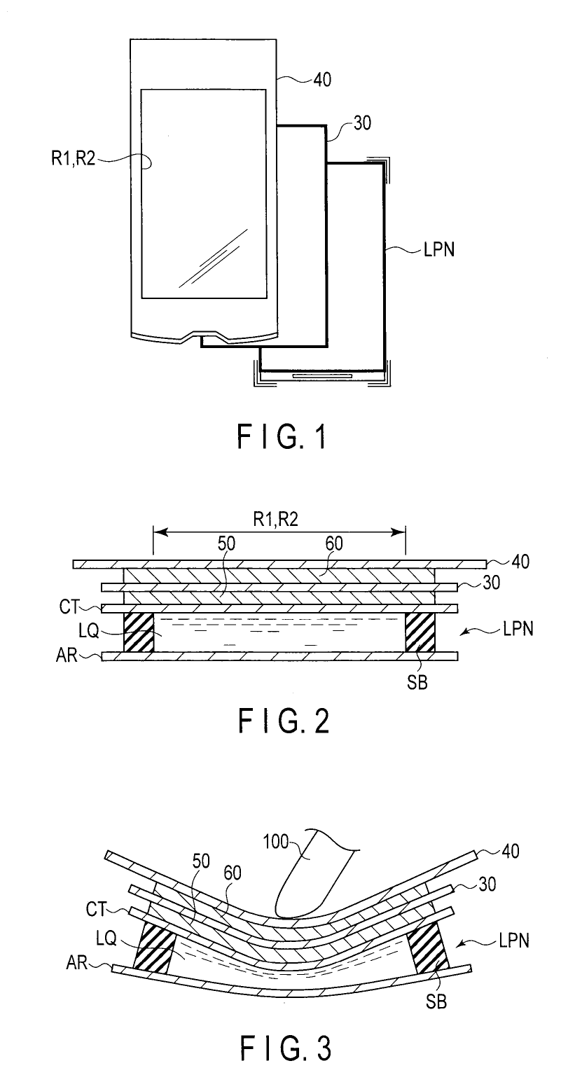

FIG. 1 is an exploded perspective view schematically showing a liquid crystal display apparatus according to an embodiment. FIG. 2 is a sectional view schematically showing the liquid crystal display apparatus. FIG. 3 is a diagram showing a state in which the liquid crystal display apparatus is pressed by an input unit.

As shown in FIGS. 1 and 2, the liquid crystal display apparatus comprises a liquid crystal display panel LPN, a sensing substrate 30, a protection board 40, and adhesives 50, 60.

The liquid crystal display panel LPN includes a display area R1 where images are displayed. The sensing substrate 30 is opposed to the display surface of the liquid crystal display panel LPN. The sensing substrate 30 includes an input area R2 opposing the display area R1. The sensing substrate 30 has a function as a touch panel and is configured to detect positional information of the location input into the input area R2.

The first adhesive 50 is laid overlapping at least the display area R1 and the input area R2 and positioned between the liquid crystal display panel LPN and the sensing substrate 30 to join the liquid crystal display panel LPN and the sensing substrate 30. As described above, the screen fit method that integrates substrates by filling a gap between the liquid crystal display panel LPN and the sensing substrate 30 with an adhesive made of transparent resin is adopted.

The adhesive 50 is formed of a material that allows at least visible light to pass through. The adhesive 50 may also be formed of a type of resin that is cured by ultraviolet rays or visible light or a type of resin that is cured by heating. Further, the adhesive 50 may have a refractive index between a refractive index of a second insulating substrate 20 (countersubstrate CT) described later and a refractive index of a glass substrate 30S (sensing substrate 30) described later. Accordingly, the reflection of light on the surface (interface) of the adhesive 50 can be reduced.

The protection board 40 is opposed to the sensing substrate 30. The protection board 40 decorates the input surface of the sensing substrate 30 (display surface of the liquid crystal display panel LPN), that is, the board that decorates the appearance of the liquid crystal display apparatus. The protection board 40 is flat and is formed of a transparent insulating material such as glass and acryl resin. In this case, the protection board 40 is further formed in a rectangular shape. The protection board 40 includes a frame area outside the display area R1 and the input area R2. A peripheral shielding layer is formed in the frame area of the protection board 40. The peripheral shielding layer can be formed by using a black resin or the like.

The second adhesive 60 is opposed to the display area R1 and the input area R2 and positioned between the sensing substrate 30 and the protection board 40 to join the sensing substrate 30 and the protection board 40. That is, the adhesive 60 is applied over the entire region of the display area R1 and the input area R2. The adhesive 60 is formed of a material that allows at least visible light to pass through. As described above, the screen fit method is adopted to join the sensing substrate 30 and the protection board 40.

The adhesive 60 may also be formed of a type of resin that is cured by ultraviolet rays or visible light or a type of resin that is cured by heating. Further, the adhesive 60 may have a refractive index between the refractive index of the glass substrate 30S (sensing substrate 30) and a refractive index of the protection board 40. Accordingly, the reflection of light on the surface (interface) of the adhesive 60 can be reduced.

As shown in FIGS. 2 and 3, the capacitive sensing method, resistance pressure sensing method, optical detection method, and electromagnetic induction method can be used as position detection methods of the sensing substrate 30. As input means 100, a finger of the operator and a conductor can be cited and they may appropriately be selected for the position detection method. In any of the methods, an external pressure is applied to the outer surface of the protection board 40 by the input means 100. The outside surface of the protection board 40 is tapped, pressed, or slid by the input means 100. An external pressure is applied, as described above, to the substrate so that the sensing substrate 30 can detect positional information of the input location.

Because, as described above, the liquid crystal display apparatus adopts the screen fit method, when compared with a case when the air gap method is adopted, an external pressure applied to the outside surface of the protection board 40 is transmitted to the liquid crystal display panel LPN more directly. Then, the thickness of a liquid crystal layer LQ described later changes. However, by configuring the liquid crystal display panel LPN as will be described later, pulling or the like is less likely to occur and degradation in display quality can be reduced and further, the liquid crystal display panel LPN capable of normally displaying input characters, pictures and the like can be obtained.

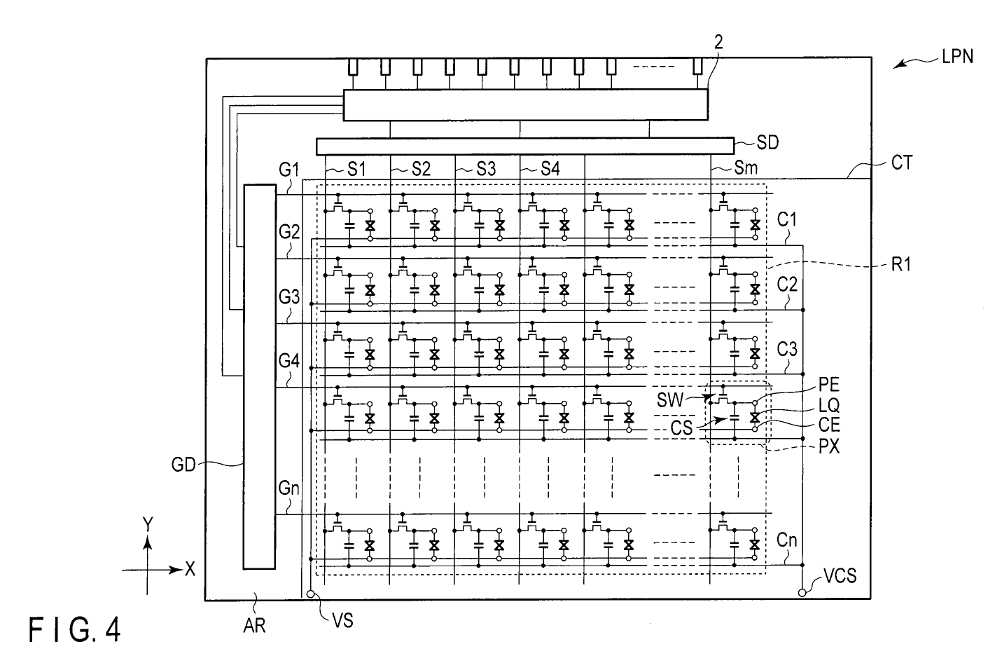

FIG. 4 is a diagram schematically showing the configuration and an equivalent circuit of the liquid crystal display panel LPN of the liquid crystal display apparatus.

As shown in FIG. 4, the liquid crystal display panel LPN is an active matrix type liquid crystal display panel. The liquid crystal display panel LPN includes an array substrate AR as a first substrate, a countersubstrate CT as a second substrate arranged opposite to the array substrate AR, and a liquid crystal layer LQ held between the array substrate AR and the countersubstrate CT. Such a liquid crystal display panel LPN includes the display area R1 that opposes the array substrate AR, the countersubstrate CT and the liquid crystal layer LQ, and displays images. In the display area R1, m×n pixels PX arranged in a matrix shape are provided (m and n are positive integers).

In the display area R1, the liquid crystal display panel LPN includes n gate wirings G (G1 to Gn), n auxiliary capacitance wirings C (C1 to Cn), and m source wirings S (S1 to Sm). The gate wiring G and the auxiliary capacitance wiring C substantially linearly extend, for example, in a first direction X. The gate wirings G and the auxiliary capacitance wirings C are alternately arranged in parallel in a second direction Y crossing the first direction X. Here, the first direction X and the second direction Y are substantially orthogonal to each other. The source wiring S crosses the gate wiring G and the auxiliary capacitance wiring C at right angles. The source wiring S substantially linearly extends in the second direction Y. Incidentally, the gate wirings G, the auxiliary capacitance wirings C, and the source wiring S do not necessarily extend linearly and a portion thereof may be curved.

Each of the gate wirings G is pulled out of the display area R1 to be connected to a gate driver GD. Each of the source wirings S is pulled out of the display area R1 to be connected to a source driver SD. At least a portion of the gate driver GD and the source driver SD is formed on, for example, the array substrate AR and connected to a drive IC chip 2 containing a controller.

Each of the pixels PX is formed of a switching element SW, a pixel electrode PE, and a common electrode CE. A retention capacitance Cs is formed between, for example, the auxiliary capacitance wiring C and the pixel electrode PE. The auxiliary capacitance wiring C is electrically connected to a voltage application unit VCS to which an auxiliary capacitance voltage is applied.

In the present embodiment, the liquid crystal display panel LPN is configured in such a way that while the pixel electrode PE is formed on the array substrate AR, at least a portion of the common electrodes CE is formed on the countersubstrate CT, and an electric field formed between the pixel electrode PE and the common electrode CE is mainly used to switch liquid crystal molecules of the liquid crystal layer LQ. The electric field formed between the pixel electrode PE and the common electrode CE is a transverse electric field containing a slightly oblique electric field with respect to the X-Y plane defined by the first direction X and the second direction Y or the principal surface of the substrate.

The switching element SW is constituted of, for example, an n-channel thin film transistor (TFT). The switching element SW is electrically connected to the gate wiring G and the source wiring S. The switching element SW may be of top gate type or bottom gate type. The switching element SW has a semiconductor layer formed of, for example, polysilicon, but the semiconductor layer may also be formed of amorphous silicon.

The pixel electrode PE is arranged in each pixel PX and is electrically connected to the switching element SW. The common electrode CE is arranged commonly to the pixel electrodes PE of a plurality of pixels PX through the liquid crystal layer LQ. The pixel electrode PE and the common electrode CE as described above are formed of a conductive material having light transmission properties such as indium tin oxide (ITO) and indium zinc oxide (IZO), but may also be formed of other metallic materials such as aluminum.

The array substrate AR includes a feed unit VS to apply a voltage to the common electrode CE. The feed unit VS is formed, for example, outside the display area R1. The common electrode CE is pulled out of the display area R1 and electrically connected to the feed unit VS via a conductive material (not shown).

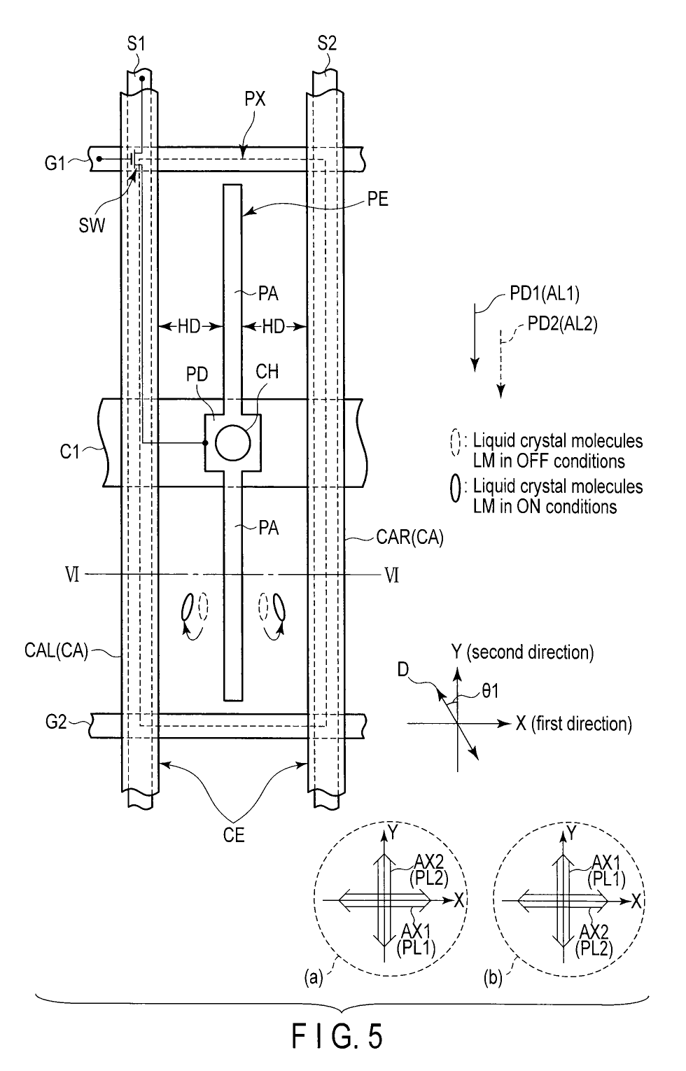

FIG. 5 is a plan view schematically showing a structure example of one pixel PX when the liquid crystal display panel LPN is viewed from a countersubstrate side. Here, a plan view in the X-Y plane is shown.

As shown in FIG. 5, the pixel PX has, as indicated by a dashed line, a rectangular shape in which the length in the first direction X is shorter than that in the second direction Y. Gate wiring G1 and gate wiring G2 extend in the first direction X. The auxiliary capacitance wiring C1 is arranged between gate wiring G1 and gate wiring G2 adjacent to each other and extends in the first direction X. Source wiring S1 and source wiring S2 extend in the second direction Y. The pixel electrode PE is arranged between source wiring S1 and source wiring S2 adjacent to each other. The pixel electrode PE is positioned between gate wiring G1 and gate wiring G2.

In the illustrated example, source wiring S1 is arranged at a left-side edge of the pixel PX and source wiring S2 is arranged at a right-side edge of the pixel PX. To be more precise, source wiring S1 is arranged extending over the boundary of the pixel PX and the adjacent pixel on the left side and source wiring S2 is arranged extending over the boundary of the pixel PX and the adjacent pixel on the right side. Gate wiring G1 is arranged at an upper-side edge of the pixel PX and gate wiring G2 is arranged at a lower-side edge of the pixel PX. To be more precise, gate wiring G1 is arranged extending over the boundary of the pixel PX and the adjacent pixel on the upper side and gate wiring G2 is arranged extending over the boundary of the pixel PX and the adjacent pixel on the lower side. The auxiliary capacitance wiring C1 is located substantially in the center of the pixel.

In the illustrated example, the switching element SW is electrically connected to gate wiring G1 and source wiring S1. The switching element SW is provided at the point of intersection of gate wiring G1 and source wiring S1 and a drain wiring thereof extends in source wiring S1 and the auxiliary capacitance wiring C1 and is electrically connected to the pixel electrode PE through a contact hole CH formed in a region opposing the auxiliary capacitance wiring C1. The switching element SW is provided in a region overlapping source wiring S1 and the auxiliary capacitance wiring C1 and hardly protrudes out of the region overlapping source wiring S1 and the auxiliary capacitance wiring C1 and restricts the reduction of area of an opening contributing to the display.

The pixel electrode PE includes a primary pixel electrode PA and a contact portion PD that are mutually electrically connected. The primary pixel electrode PA has a major axis in the second direction Y. The primary pixel electrode PA linearly extends in the second direction Y from the contact portion PD up to the vicinity of the upper-side edge and the lower-side edge of the pixel PX. The primary pixel electrode PA described above is formed in a band shape having substantially the same width in the first direction X. The contact portion PD is positioned in a region opposing the auxiliary capacitance wiring C1 and electrically connected to the switching element SW through the contact hole CH. The contact portion PD is formed wider than the primary pixel electrode PA.

The pixel electrode PE is arranged in a substantially intermediate position, between source wiring S1 and source wiring S2, that is, the center of the pixel PX. The interval between source wiring S1 and the pixel electrode PE in the first direction X is substantially equal to the interval between source wiring S2 and the pixel electrode PE in the first direction X.

The common electrode CE includes a primary common electrode CA. The pixel PX includes a pair of primary common electrodes CA. The pair of primary common electrodes CA is positioned to sandwich the primary pixel electrode PA in the first direction X on the X-Y plane and has the major axis in the second direction Y. Here, the primary common electrode CA linearly extends in the second direction Y. Alternatively, the primary common electrode CA is opposed to the respective source wirings S and extends substantially in parallel with the primary pixel electrode PA. The primary common electrode CA described above is formed in a band shape having substantially the same width in the first direction X.

In the illustrated example, two primary common electrodes CA run in parallel in the first direction X and are arranged at the left-side and right-side edges of the pixel PX. To distinguish these primary common electrodes CA below, the primary common electrode CA on the left side in FIG. 5 will be called CAL and the primary common electrode CA on the right side in FIG. 5 will be called CAR. Primary common electrode CAL is opposed to source wiring S1 and primary common electrode CAR is opposed to source wiring S2. Primary common electrode CAL and primary common electrode CAR are mutually electrically connected inside or outside the display area R1.

In the pixel PX, primary common electrode CAL is arranged at the left-side edge and primary common electrode CAR is arranged at the right-side edge. To be more precise, primary common electrode CAL is arranged extending over the boundary of the pixel PX and the adjacent pixel on the left side and primary common electrode CAR is arranged extending over the boundary of the pixel PX and the adjacent pixel on the right side.

Focusing on the spatial relationship between the pixel electrode PE and the primary common electrode CA, it is found that the pixel electrode PE and the primary common electrode CA are arranged alternately in the first direction X. The pixel electrode PE and the primary common electrode CA are arranged substantially in parallel with each other. In this case, none of the primary common electrodes CA opposes the pixel electrode PE on the X-Y plane.

That is, one pixel electrode PE is positioned between primary common electrode CAL and primary common electrode CAR adjacent to each other. In other words, primary common electrode CAL and primary common electrode CAR are arranged to sandwich the position directly above the pixel electrode PE. Alternatively, the pixel electrode PE is arranged between primary common electrode CAL and primary common electrode CAR. Thus, primary common electrode CAL, the primary pixel electrode PA, and primary common electrode CAR are arranged in this order in the first direction X.

The interval between the pixel electrode PE and the common electrode CE in the first direction X is substantially constant. That is, the interval between primary common electrode CAL and the primary pixel electrode PA in the first direction X and the interval between primary common electrode CAR and the primary pixel electrode PA in the first direction X are substantially equal.

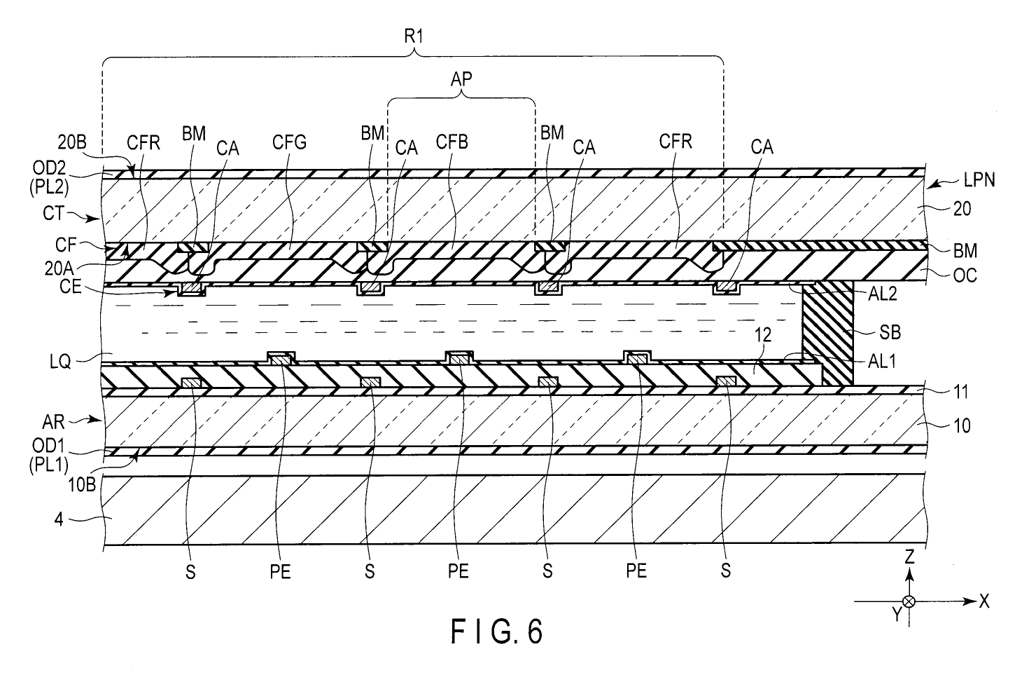

FIG. 6 is a sectional view of the liquid crystal display panel LPN schematically showing a section structure when cut along line VI-VI in FIG. 5. Here, only portions necessary for description are shown.

As shown in FIG. 6, a backlight unit 4 is arranged on the rear side of the array substrate AR constituting the liquid crystal display panel LPN. Various forms of units can be applied as the backlight unit 4 and units using a light emitting diode (LED) or cold-cathode tube (CCFL) can be applied and here, a description of a detailed structure thereof is omitted.

The array substrate AR is formed using a first insulating substrate 10 having light transmission properties. A source wiring S is provided on a first interlayer insulating film 11 to be covered with a second interlayer insulating film 12. Gate wirings and auxiliary capacitance wirings that are not shown are formed between, for example, the first insulating substrate 10 and the first interlayer insulating film 11. The pixel electrode PE is provided on the second interlayer insulating film 12. The pixel electrode PE is positioned on the inner side of the position directly above each of the adjacent source wirings S.

A first alignment film AL1 is arranged on the surface of the array substrate AR opposite to the countersubstrate CT and extends over substantially the entire display area R1. The first alignment film AL1 covers the pixel electrode PE and others and is arranged also on the second interlayer dielectric 12. The first alignment film AL1 described above is formed of a material showing horizontal alignment.

The array substrate AR may further include a portion of the common electrode CE.

The countersubstrate CT is formed using a second insulating substrate 20 having light transmission properties. The countersubstrate CT includes a black matrix BM, a color filter CF, an overcoat layer OC, the common electrode CE, a second alignment film AL2, and the like.

The black matrix BM demarcates each pixel PX and forms an opening AP opposite to the pixel electrode PE. That is, the black matrix BM is arranged so as to be opposite to a wiring portion such as the source wiring S, gate wiring, auxiliary capacitance wiring, and switching element. Here, only a portion of the black matrix BM extending in the second direction Y is illustrated, but a portion extending in the first direction X may also be included. The black matrix BM is arranged on an inner surface 20A of the second insulating substrate 20 opposite to the array substrate AR.

The color filter CF is arranged corresponding to each pixel PX. That is, the color filter CF is arranged in the opening AP on the inner surface 20A of the second insulating substrate 20 and also a portion thereof goes up onto the black matrix BM. The color filters CF arranged in the pixels PX adjacent in the first direction X have mutually different colors. For example, the color filters CF are formed of resin materials each colored in one of three primary colors like red, blue, and green. A red color filter CFR made of a resin material colored in red is arranged corresponding to a red pixel. A blue color filter CFB made of a resin material colored in blue is arranged corresponding to a blue pixel. A green color filter CFG made of a resin material colored in green is arranged corresponding to a green pixel. The boundary of these color filters CF is in position opposing the black matrix BM.

The overcoat layer OC covers the color filter CF. The overcoat layer OC mitigates the influence of unevenness of the surface of the color filter CF.

The common electrode CE is formed on the side opposite to the array substrate AR of the overcoat layer OC. The interval between the common electrode CE and the pixel electrode PE in a third direction Z is substantially uniform. The third direction Z is a direction orthogonal to the first direction X and the second direction Y or the normal direction of the liquid crystal display panel LPN.

The second alignment film AL2 is arranged on the surface of the countersubstrate CT opposite to the array substrate AR and extends over substantially the entire display area R1. The second alignment film AL2 covers the common electrode CE and the overcoat layer OC. The second alignment film AL2 described above is formed of a material showing horizontal alignment.

The first alignment film AL1 and the second alignment film AL2 are alignment-treated (such as rubbing and photo alignment treatment) for initial alignment of liquid crystal molecules of the liquid crystal layer LQ. A first alignment treatment direction PD1 for initial alignment of liquid crystal molecules by the first alignment film AL1 and a second alignment treatment direction PD2 for initial alignment of liquid crystal molecules by the second alignment film AL2 are parallel to each other and oriented in opposite directions or in the same direction. For example, the first alignment treatment direction PD1 and the second alignment treatment direction PD2 are, as shown in FIG. 5, substantially parallel to the second direction Y and oriented in the same direction.

The array substrate AR and the countersubstrate CT as described above are arranged in such a way that the first alignment film AL1 and the second alignment film AL2 are opposite to each other respectively. In this case, columnar spacers formed of, for example, a resin material integrally with one substrate is arranged between the first alignment film AL1 of the array substrate AR and the second alignment film AL2 of the countersubstrate CT, thereby forming a predetermined cell gap, for example, a cell gap of 2 to 7 μm. The cell gap of the liquid crystal layer is smaller than the interval between the primary pixel electrode PA and the primary common electrode CA. The array substrate AR and the countersubstrate CT are pasted together by a sealant SB outside the display area R1 while the predetermined gap is formed.

The liquid crystal layer LQ is held by the cell gap formed between the array substrate AR and the countersubstrate CT and arranged between the first alignment film AL1 and the second alignment film AL2. Such a liquid crystal layer LQ has, for example, positive dielectric anisotropy and thus is formed of p-type liquid crystals.

A first optical element OD1 is pasted to the outside surface of the array substrate AR, that is, an outside surface 10B of the first insulating substrate 10 constituting the array substrate AR using an adhesive or the like. The first optical element OD1 is positioned on the side opposite to the backlight unit 4 of the liquid crystal display panel LPN and controls the polarization state of incident light incident on the liquid crystal display panel LPN from the backlight unit 4. The first optical element OD1 contains a first polarizer PL1 having a first polarization axis (or a first absorption axis) AX1.

A second optical element OD2 is pasted to the outside surface of the countersubstrate CT, that is, an outside surface 20B of the second insulating substrate 20 constituting the countersubstrate CT using an adhesive or the like. The second optical element OD2 is positioned on the display surface side of the liquid crystal display panel LPN and controls the polarization state of emitted light emitted from the liquid crystal display panel LPN. The second optical element OD2 contains a second polarizer PL2 having a second polarization axis (or a second absorption axis) AX2.

The first polarizer PL1 and the second polarizer PL2 are cross Nicol-arranged and the first polarization axis AX1 and the second polarization axis AX2 are in an orthogonal spatial relationship. In this case, one polarizer is arranged so that the polarization axis thereof is parallel to or orthogonal to the initial alignment direction of liquid crystal molecules, that is, the first alignment treatment direction PD1 or the second alignment treatment direction PD2. If the initial alignment direction is parallel to the second direction Y, the polarization axis of one polarizer is parallel to the second direction Y or the first direction X.

In the example shown in (a) of FIG. 5, the first polarizer PL1 is arranged so that the first polarization axis AX1 thereof is orthogonal to the initial alignment direction (second direction Y) of liquid crystal molecules LM (that is, parallel to the first direction X) and the second polarizer PL2 is arranged so that the second polarization axis AX2 thereof is parallel to the initial alignment direction of the liquid crystal molecules LM (that is, parallel to the second direction Y).

In the example shown in (b) of FIG. 5, the second polarizer PL2 is arranged so that the second polarization axis AX2 thereof is orthogonal to the initial alignment direction (second direction Y) of the liquid crystal molecules LM (that is, parallel to the first direction X) and the first polarizer PL1 is arranged so that the first polarization axis AX1 thereof is parallel to the initial alignment direction of the liquid crystal molecules LM (that is, parallel to the second direction Y).

Next, the operation of the liquid crystal display panel LPN configured as described above will be described.

As shown in FIGS. 5 and 6, the liquid crystal molecules LM of the liquid crystal layer LQ are aligned so that the major axis thereof is aligned toward the first alignment treatment direction PD1 of the first alignment film AL1 or the second alignment treatment direction PD2 of the second alignment film AL2 in a state in which no voltage is applied to the liquid crystal layer LQ, that is, no potential difference (or no electric field) is formed between the pixel electrode PE and the common electrode CE (during off conditions). Such off conditions correspond to the initial alignment state and the alignment direction of the liquid crystal molecules LM during off conditions corresponds to the initial alignment direction.

To be more precise, the liquid crystal molecules LM are not necessarily aligned in parallel with the X-Y plane and are frequently pre-tilted. Thus, the initial alignment direction of the liquid crystal molecules LM is a direction obtained by an orthogonal projection of the major axis of the liquid crystal molecules LM during off conditions onto the X-Y plane. To simplify the description below, it is assumed that the liquid crystal molecules LM are aligned in parallel with the X-Y plane and rotate in a plane parallel to the X-Y plane.

Here, both of the first alignment treatment direction PD1 and the second alignment treatment direction PD2 are directions substantially parallel to the second direction Y. The major axis of the liquid crystal molecules LM during off conditions is initially aligned, as indicated by a dashed line in FIG. 5, in a direction substantially parallel to the second direction Y. That is, the initial alignment direction of the liquid crystal molecules LM is parallel to the second direction Y (or 0° with respect to the second direction Y).

If, like the illustrated example, the first alignment treatment direction PD1 and the second alignment treatment direction PD2 are parallel and oriented in the same direction, the liquid crystal molecules LM are aligned substantially horizontally (the pre-tilt angle is substantially zero) near an intermediate portion of the liquid crystal layer LQ in the cross section of the liquid crystal layer LQ, and with this point as a boundary, the liquid crystal molecules LM are aligned with a pre-tilt angle so as to be symmetric in the vicinity of the first alignment film AL1 and the vicinity of the second alignment film AL2 (spray alignment).

As a result of treating the first alignment film AL1 for alignment in the first alignment treatment direction PD1, the liquid crystal molecules LM near the first alignment film AL1 are initially aligned in the first alignment treatment direction PD1 and as a result of treating the second alignment film AL2 for alignment in the second alignment treatment direction PD2, the liquid crystal molecules LM near the second alignment film AL2 are initially aligned in the second alignment treatment direction PD1. If the first alignment treatment direction PD1 and the second alignment treatment direction PD2 are parallel to each other and oriented in the same direction, as described above, the liquid crystal molecules LM are in a spray alignment and with the intermediate portion of the liquid crystal layer LQ as a boundary, as described above, the alignment of the liquid crystal molecules LM near the first alignment film AL1 on the array substrate AR and the alignment of the liquid crystal molecules LM near the second alignment film AL2 on the countersubstrate CT are symmetric with respect to a horizontal line. Thus, optical compensation is made also in a direction tilted from the normal direction of the substrate. Therefore, if the first alignment treatment direction PD1 and the second alignment treatment direction PD2 are parallel to each other and oriented in the same direction, light leakage in the black display is small so that it becomes possible to realize a high contrast ratio and to improve display quality.

If the first alignment treatment direction PD1 and the second alignment treatment direction PD2 are parallel to each other and oriented in opposite directions, the liquid crystal molecules LM are aligned with a substantially uniform pre-tilt angle near the first alignment film AL1, near the second alignment film AL2, and in the intermediate portion of the liquid crystal layer LQ in the cross section of the liquid crystal layer LQ (homogeneous alignment).

A portion of backlight from the backlight unit 4 passes through the first polarizer PL1 followed by entering the liquid crystal display panel LPN. The polarization state of the light that has entered the liquid crystal display panel LPN depends on the alignment state of the liquid crystal molecules LM when passing through the liquid crystal layer LQ. The light that has passed through the liquid crystal layer LQ during off conditions is absorbed by the second polarizer PL2 (black display).

On the other hand, when a voltage is applied to the liquid crystal layer LQ, that is, a potential difference (or an electric field) is formed between the pixel electrode PE and the common electrode CE (during on conditions), a transverse electric field substantially parallel to the substrate is formed between the pixel electrode PE and the common electrode CE. Under the influence of the electric field, the major axis of the liquid crystal molecules LM rotates, as indicated by a continuous line in FIG. 5, in a plane substantially parallel to the X-Y plane.

In the example shown in FIG. 5, the liquid crystal molecules LM in a region between the pixel electrode PE and primary common electrode CAL rotate clockwise with respect to the second direction Y and are aligned toward the lower left in FIG. 5. The liquid crystal molecules LM in a region between the pixel electrode PE and primary common electrode CAR rotate counterclockwise with respect to the second direction Y and are aligned to be directed toward the lower right in FIG. 5.

Thus, in a state in which an electric field is formed between the pixel electrode PE and the common electrode CE in each pixel PX, the alignment direction of the liquid crystal molecules LM is divided into a plurality of directions with the position opposing the pixel electrode PE acting as a boundary to form a domain in each alignment direction. That is, a plurality of domains is formed in each pixel PX.

Because, as described above, the liquid crystal layer LQ is formed of p-type liquid crystals, the major axis of the liquid crystal molecules LM is aligned in a direction along an oblique electric field. If the angle from the X-axis on the X-Y plane is set as an azimuth angle and the normal direction with respect to the X-Y plane is set as the Z-axis, the angle from the Z-axis is set as a polar angle. If a voltage is applied to between electrodes, a transverse electric field is produced between the pixel electrode PE and the common electrode CE and the transverse electric field is produced, for example, in FIG. 5, bilaterally symmetrically with respect to the pixel electrode PE. Because of the first alignment treatment direction being parallel to the second direction as an extension direction of the pixel electrode PE and the second alignment treatment direction being parallel to the second direction as an extension direction of the common electrode CE, when the transverse electric field is produced, liquid crystal molecules are aligned bilaterally symmetrically with respect to the pixel electrode PE. That is, when an electric field is produced, the alignment direction of liquid crystal molecules between a pixel electrode and a common electrode is uniquely determined. Accordingly, both of the polar angle and the azimuth angle of the liquid crystal molecules LM can be specified and thus, the alignment control force (alignment strength) of liquid crystal molecules is strong. If the first alignment treatment direction and the second alignment treatment direction are parallel to any axis of symmetry of the pixel electrode or the common electrode, both of the polar angle and the azimuth angle of the liquid crystal molecules LM can similarly be specified.

The inventors of the present application applied an external force to the outside surface of the protection board 40 to check for an occurrence of pulling and they discovered that no pulling occurred at all in a liquid crystal display apparatus formed as described above.

The inventors of the present application also produced the liquid crystal display apparatus whose display mode was switched to the vertical alignment (VA) mode, multi-domain vertical alignment (MVA) mode, in-plane switching (IPS) mode, and fringe field switching (FFS) mode to check for an occurrence of pulling in these liquid crystal display apparatuses. Investigation results show that a pulling occurs in the liquid crystal display apparatus of all display modes if an external pressure is applied.

A portion of backlight entering the liquid crystal display panel LPN from the backlight unit 4 during such on conditions passes through the first polarizer PL1 followed by entering the liquid crystal display panel LPN. The backlight having entered the liquid crystal layer LQ changes its polarization state. During such on conditions, at least a portion of light having passed through the liquid crystal layer LQ passes through the second polarizer PL2 (white display).

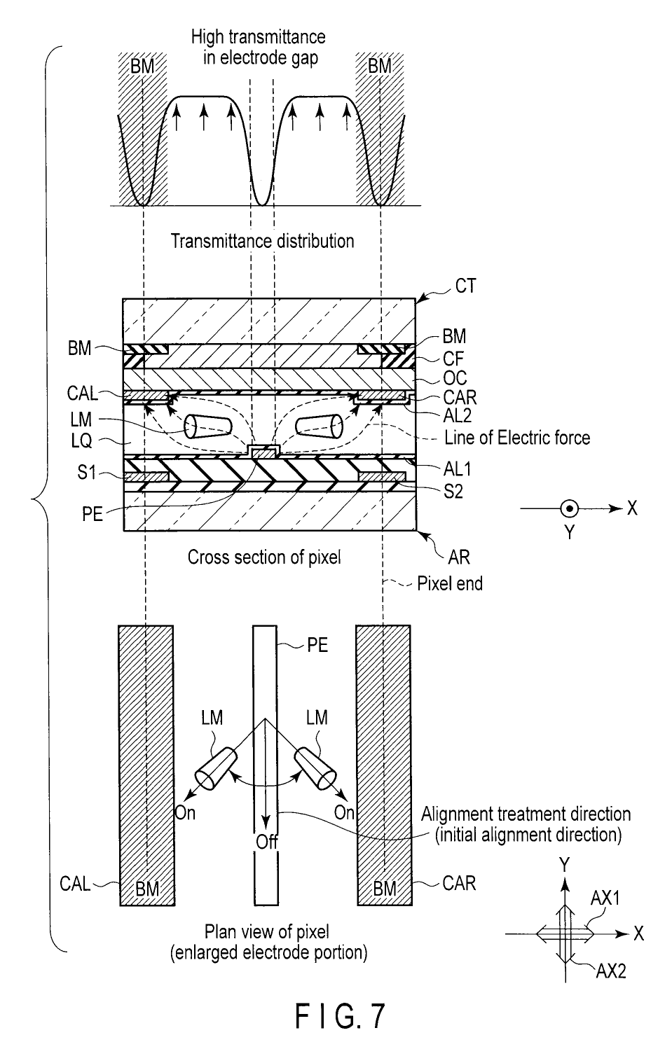

FIG. 7 is a diagram illustrating an electric field formed between the pixel electrode PE and the common electrode CE in the liquid crystal display panel LPN shown in FIG. 5 and a relationship between a director of the liquid crystal molecules LM and transmittance by the electric field.

As shown in FIG. 7, the liquid crystal molecules LM are initially aligned in a direction substantially parallel to the second direction Y during off conditions. During on conditions in which a potential difference is formed between the pixel electrode PE and the common electrode CE, the optical percentage modulation of the liquid crystal is the highest (that is, the transmittance is the highest in an opening) when the director of the liquid crystal molecules LM (or the major axis direction of the liquid crystal molecules LM) is shifted by about 45° with respect to the first polarization axis AX1 of the first polarizer PL1 and the second polarization axis AX2 of the second polarizer PL2 in the X-Y plane.

In the illustrated example, the directors of the liquid crystal molecules LM between primary common electrode CAL and the pixel electrode PE are substantially parallel at azimuth angles 45°, −225° in the X-Y plane, and the directors of the liquid crystal molecules LM between primary common electrode CAR and the pixel electrode PE are substantially parallel at azimuth angles 135°, −315° in the X-Y plane to achieve the peak transmittance. Focusing on the transmittance distribution per pixel, it is found that, while the transmittance is substantially zero on the pixel electrode PE and the common electrode CE, a high transmittance is gained over substantially the entire region of the electrode gap between the pixel electrode PE and the common electrode CE.

Primary common electrode CAL positioned directly above source wiring S1 and primary common electrode CAR positioned directly above source wiring S2 are each opposed to the black matrix BM, and the both primary common electrode CAL and primary common electrode CAR have a width equal to or less than the width of the black matrix BM in the first direction X and do not extend to the side of the pixel electrode PE from the position opposing the black matrix BM. Thus, an opening contributing to the display per pixel corresponds to a region between the pixel electrode PE and primary common electrode CAL and a region between the pixel electrode PE and primary common electrode CAR of regions between the black matrices BM or between source wiring S1 and source wiring S2.

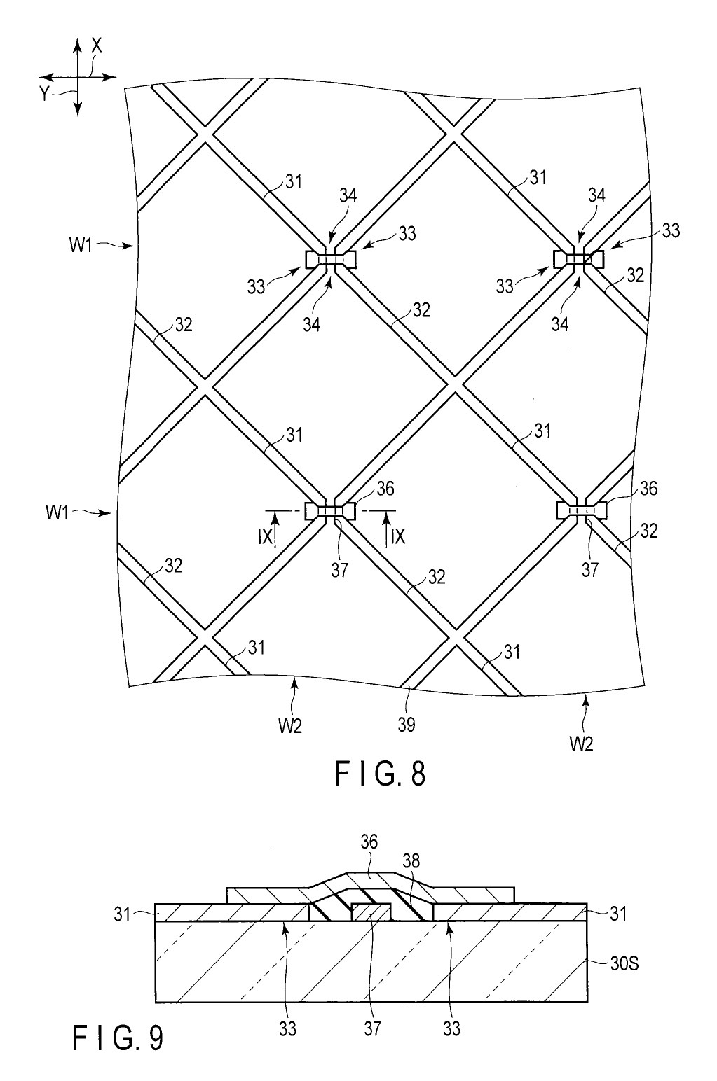

FIG. 8 is an enlarged plan view showing a portion of the sensing substrate 30, and FIG. 9 is a sectional view showing a portion of the sensing substrate 30 along line IX-IX in FIG. 8.

As shown in FIGS. 3, 8, and 9, the capacitive sensing method is used as the position detection method of the sensing substrate 30. The sensing substrate 30 detects input positional information by the input means 100 from the front side of the protection board 40. The sensing substrate 30 includes a glass substrate 30S as a transparent insulating substrate.

The sensing substrate 30 includes a plurality of first detection electrodes 31 and a plurality of second detection electrodes 32 as detection electrodes whose electrostatic capacitance changes depending on input by the input means 100. The electrode pattern of the sensing substrate 30 contains, in addition to the plurality of first detection electrodes 31 and the plurality of second detection electrodes 32, a plurality of connection wirings 36 and a plurality of connection wirings 37.

The first detection electrodes 31, the second detection electrodes 32, the connection wirings 36, and the connection wirings 37 are arranged on the glass substrate 30S in an input area R2, opposed to the protection board 40, and formed of, for example, indium tin oxide (ITO) as a transparent conductive material.

The first detection electrodes 31 are arranged in the first direction X and the second direction Y. Each of the first detection electrodes 31 is a square having diagonals in the first direction X and the second direction Y. The first detection electrode 31 includes first corners opposite to each other in the first direction X. The adjacent first corners are connected in the first direction X.

In the present embodiment, the first corner of the square of the first detection electrode 31 is collapsed to create a first short side 33. Thus, the first detection electrode 31 is a hexagon having the first short side 33. The adjacent first short sides 33 are connected each other via the connection wiring 36. The connection wirings 36 are arranged on the glass substrate 30S in an island shape.

The first detection electrodes 31 and the plurality of connection wirings 36 connected mutually form a first wiring W1 extending in the first direction X. A plurality of first wirings W1 is arranged in the second direction Y. The plurality of first detection electrodes 31 and the plurality of connection wirings 36 are formed by mutually different manufacturing processes. The X-coordinate of the input position can be detected by detecting a change in electrostatic capacitance using the first wirings W1.

The second detection electrodes 32 are arranged in the first direction X and the second direction Y with spacing from the first detection electrodes 31. Each of the second detection electrodes 32 is a square having diagonals in the first direction X and the second direction Y. The second detection electrode 32 includes second corners opposite to each other in the second direction Y. The adjacent second corners are connected each other in the second direction Y.

In the present embodiment, the second corner of the square of the second detection electrode 32 is collapsed to create a second short side 34. Thus, the second detection electrode 32 is a hexagon having the second short side 34. The adjacent second short sides 34 are connected each other via the connection wiring 37. The connection wirings 37 are arranged on the glass substrate 30S in an island shape.

The plurality of second detection electrodes 32 and the plurality of connection wirings 37 connected mutually form a second wiring W2 extending in the second direction Y. A plurality of second wirings W2 is arranged in the first direction X. The plurality of second detection electrodes 32 and the plurality of connection wirings 37 of the second wiring W2 are integrally formed by the same manufacturing process. The Y-coordinate of the input position can be detected by detecting a change in electrostatic capacitance using the second wirings W2.

A slit 39 in a lattice shape is formed between the first detection electrode 31 and the second detection electrode 32.

A plurality of dielectric films 38 is arranged in an island shape on the glass substrate 30S. The dielectric films 38 is arranged at a plurality of intersections of the first wirings W1 and the second wirings W2 on the glass substrate 30S and interposed between the first wirings W1 and the second wirings W2. The dielectric film 38 is intended to prevent short-circuits between the first wirings W1 and the second wirings W2. In the present embodiment, the dielectric film 38 is formed of an organic insulating material.

The connection wiring 36 and the connection wiring 37 are opposed via the dielectric film 38. Here, the first wiring W1 (connection wiring 36) is positioned above the intersection of the first wiring W1 and the second wiring W2. From the above, the connection wiring 36 can be called a bridge wiring.

The first wiring W1 and the second wiring W2 are connected to a control unit (not shown). The control unit can acquire input position information (input position coordinates) by acquiring changes in electrostatic capacitance in the first wiring W1 (first detection electrode 31) and the second wiring W2 (second detection electrode 32).

According to a liquid crystal display apparatus configured as described above, the liquid crystal display apparatus includes the liquid crystal display panel LPN, the sensing substrate 30, the protection board 40, and the adhesives 50, 60. The liquid crystal display panel LPN includes the array substrate AR having the pixel electrode PE, the countersubstrate CT having the common electrode CE, the liquid crystal layer LQ, the display area R1, and the pixel PX. The pixel electrode PE includes the primary pixel electrode PA having the major axis in the second direction Y. The common electrode CE includes a pair of the primary common electrodes CA positioned to sandwich the primary pixel electrode PA in the first direction X and having the major axis in the second direction Y.

The liquid crystal display panel LPN and the sensing substrate 30, and the sensing substrate 30 and the protection board 40 are each joined by the screen fit method. Because the reflection of light on the outside surfaces (interfaces) of the liquid crystal display panel LPN, the sensing substrate 30 and the protection board 40 can be reduced, degradation in appearance of display images can be reduced.

The liquid crystal layer LQ is formed of p-type liquid crystals and a transverse electric field having an oblique electric field component is applied to the liquid crystal layer LQ. Both of the polar angle and the azimuth angle of the liquid crystal molecules LM can be specified and the alignment control force (alignment strength) of liquid crystal molecules is strong and therefore, an occurrence of pulling can be prevented.

From the above, a liquid crystal display apparatus in which pulling is less likely to occur can be obtained.

A conduction pattern of the sensing substrate 30 is formed on the side of the outside surface of the countersubstrate CT. Electrification on the side of the outside surface of the countersubstrate CT can be reduced by the conduction pattern. Therefore, the electrification can be reduced without taking electrification prevention measures such as forming a conducting film of a material such as ITO on the side of the outside surface of the countersubstrate CT (the surface of the second insulating substrate 20 or the surface of the second optical element OD2).

Further, according to the present embodiment, a high transmittance is gained in an electrode gap between the pixel electrode PE and the common electrode CE and therefore, the transmittance per pixel can be made sufficiently high by increasing a inter-electrode distance between the pixel electrode PE and primary common electrode CAL and a inter-electrode distance between the pixel electrode PE and primary common electrode CAR. Moreover, for product specifications of different pixel pitches, peak conditions of the transmittance distribution as shown in FIG. 7 can be usable by changing the inter-electrode distance (that is, by changing the arrangement position of the primary common electrode CA with respect to the pixel electrode PE arranged in a substantial center of the pixel PE). That is, in a display mode according to the present embodiment, products of various pixel pitches can be provided by setting the inter-electrode distance without necessarily needing fine electrode workings, ranging from product specifications of low resolution of a relatively large pixel pitch to product specifications of high resolution of a relatively small pixel pitch. Therefore, requirements of high transmittance and high resolution can easily be realized.

Further, according to the present embodiment, as shown in FIG. 7, focusing on the transmittance distribution in a region opposing the black matrix BM, it is found that the transmittance is sufficiently decreased. This is because no leakage of electric field to the outside of the pixel from the position of the common electrode CE occurs and no undesired transverse electric field is produced between adjacent pixels located to sandwich the black matrix BM and thus, liquid crystal molecules in a region overlapping the black matrix BM primarytain the initial alignment state like during off conditions (or when black is displayed). Therefore, even if adjacent pixels have color filters of different colors, the occurrence of color mixing can be restricted so that lower color reproducibility and a lower contrast ratio can be restricted.

When displacements of the array substrate AR and the countersubstrate CT are caused, a difference of horizontal inter-electrode distances of the common electrodes CE on both sides across the pixel electrode PE may arise. However, such displacements arise for all the pixels PX in common and therefore, there is no difference of the distribution of electric field between the pixels PX and the influence thereof on the display of images is extremely small. Furthermore, even if displacements arise between the array substrate AR and the countersubstrate CT, undesired leakage of electric field to adjacent pixels can be restricted. Therefore, even if adjacent pixels have color filters of different colors, the occurrence of color mixing can be restricted so that lower color reproducibility and a lower contrast ratio can be restricted.

Further, according to the present embodiment, the primary common electrode CA is opposed to the respective source wirings S. Particularly when primaryprimary common electrode CAL and primaryprimary common electrode CAR are arranged directly above source wiring S1 and source wiring S2 respectively, compared with a case when primaryprimary common electrode CAL and primaryprimary common electrode CAR are arranged to the pixel electrode PE side of source wiring S1 and source wiring S2, the opening AP can be enlarged and so the transmittance of the pixel PX can be improved.

Also by arranging primaryprimary common electrode CAL and primaryprimary common electrode CAR directly above source wiring S1 and source wiring S2 respectively, the inter-electrode distance between the pixel electrode PE, and primaryprimary common electrode CAL or primaryprimary common electrode CAR can be increased so that a more horizontal transverse electric field can be formed. Therefore, a wider range of viewing angle as an advantage of the IPS mode, which is a conventional configuration, or the like, can also be maintained. Moreover, the liquid crystal display apparatus excels in high-speed response and is specialized in, as described above, alignment stability.

Further, according to the present embodiment, a plurality of domains can be formed in a pixel. Therefore, the viewing angle can optically be compensated for in a plurality of directions so that a wider range of viewing angle can be achieved.

A transverse electric field (oblique electric field) is hardly formed (or a sufficient electric field to drive the liquid crystal molecules LM is not formed) on the pixel electrode PE or the common electrode CE even during on conditions and thus, like during off conditions, the liquid crystal molecules LM hardly move from the initial alignment direction. Thus, even if the pixel electrode PE and the common electrode CE are formed of a conductive material having light transmission properties such as ITO, backlight is hardly passed through these regions, and hardly contributes to the display during on conditions. Therefore, the pixel electrode PE or the common electrode CE do not necessarily need to be formed of a transparent conductive material and may be formed of a conductive material such as aluminum, silver, and copper.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above example, for example, a case when the initial alignment direction of the liquid crystal molecules LM is parallel to the second direction Y is described, but may be, as shown in FIG. 5, an oblique direction D obliquely crossing the second direction Y. An angle θ1 formed by the initial alignment direction D with the second direction Y is larger than 0° and smaller than 45°. From the perspective of alignment control of the liquid crystal molecules LM, it is extremely effective to set angle θ1 to about 5 to 30°, more desirably to 20° or less. That is, the initial alignment direction of the liquid crystal molecules LM is desirably substantially parallel to a direction within the range of 0 to 20° with respect to the second direction Y.

In the above example, a case when the liquid crystal layer LQ is constituted of a liquid crystal material whose dielectric anisotropy is positive (positive type) is described, but the liquid crystal layer LQ may also be constituted of a liquid crystal material whose dielectric anisotropy is negative, that is, may be formed of n-type liquid crystals. In this case, both of the polar angle and the azimuth angle can be specified by an electric field by at least the pixel electrode PE having a secondary pixel electrode formed by extending in the first direction X and the alignment control force of liquid crystal molecules can be made stronger so that pulling occurrence can be inhibited. Though a detailed description is omitted, because the dielectric constant anisotropy is reversed between positive and negative, it is preferable to set the above angle θ1 to 45 to 90°, desirably 70° or more for n-type liquid crystals.

In the present embodiment, the structure of the pixel PX is not limited to the example shown in FIG. 5 and various modifications may be made.

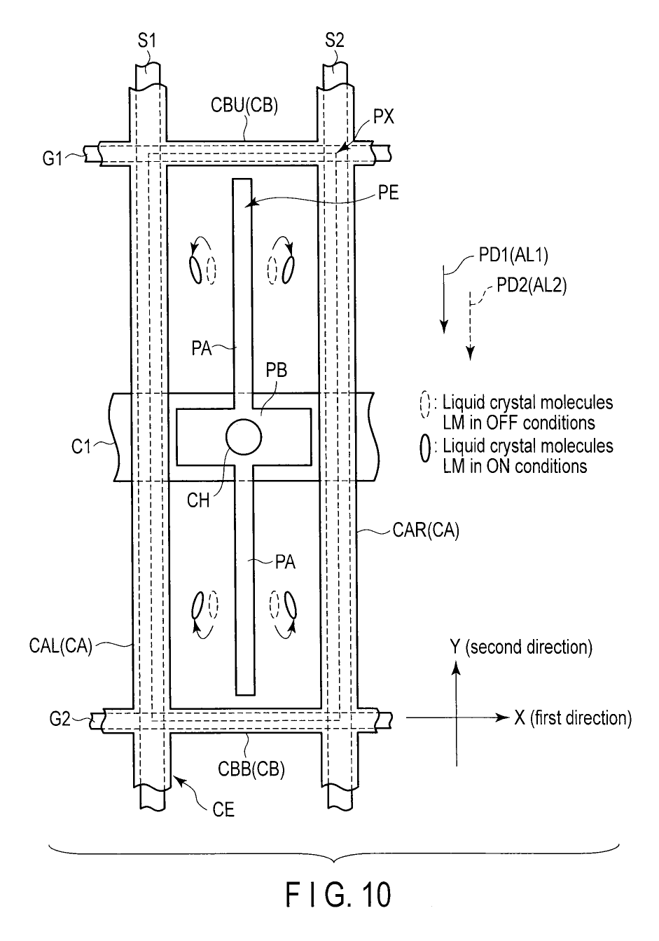

FIG. 10 is a plan view schematically showing another structure example of one pixel PX when the liquid crystal display panel LPN shown in FIG. 4 is viewed from the countersubstrate side

As shown in FIG. 10, when compared with the structure example shown in FIG. 5, the structure example is different in that a pixel electrode PE is formed in a cross shape and a common electrode CE is formed in a lattice shape like surrounding one pixel PX.

That is, the pixel electrode PE includes a primary pixel electrode PA and a secondary pixel electrode PB that are mutually electrically connected. The primary pixel electrode PA has the major axis in a second direction Y and linearly extends in the second direction Y from the secondary pixel electrode PB up to the vicinity of the upper-side edge and the lower-side edge of the pixel PX. The secondary pixel electrode PB extends in a first direction X. The secondary pixel electrode PB is positioned in a region opposing an auxiliary capacitance wiring C1 and electrically connected to a switching element through a contact hole CH. In the illustrated example, the secondary pixel electrode PB is provided in a substantial center of the pixel PX and the pixel electrode PE is formed in a cross shape.

The common electrode CE includes, in addition to a primary common electrode CA, a pair of secondary common electrodes CB positioned to sandwich the secondary pixel electrode PB in the second direction Y and formed by extending in the first direction X. The primary common electrode CA and the secondary common electrode CB are formed integrally or successively. The secondary common electrode CB is opposed to gate wiring G. In the illustrated example, two secondary common electrodes CB run in parallel in the first direction X. To distinguish these secondary common electrodes CB below, the secondary common electrode on the upper side in FIG. 10 will be called CBU and the secondary common electrode on the lower side in FIG. 10 will be called CBB. Secondary common electrode CBU is arranged at the upper-side edge of the pixel PX and opposed to gate wiring G1. That is, secondary common electrode CBU is arranged extending over the boundary between the pixel PX and the pixel adjacent on the upper side. Secondary common electrode CBB is arranged at the lower-side edge of the pixel PX and opposed to gate wiring G2. That is, secondary common electrode CBB is arranged extending over the boundary between the pixel PX and the pixel adjacent on the lower side.

Focusing on the spatial relationship between the pixel electrode PE and the common electrode CE, it is found that the primary pixel electrode PA and the primary common electrode CA are arranged alternately in the first direction X, and the secondary pixel electrode PB and the secondary common electrode CB are arranged alternately in the second direction Y. That is, one primary pixel electrode PA is positioned between primary common electrode CAL and primary common electrode CAR adjacent to each other, and primary common electrode CAL, the primary pixel electrode PA, and primary common electrode CAR are arranged in this order in the first direction X. Further, one secondary pixel electrode PB is positioned between secondary common electrode CBB and secondary common electrode CBU adjacent to each other, and secondary common electrode CBB, the secondary pixel electrode PB, and secondary common electrode CBU are arranged in this order in the second direction Y. The liquid crystal layer LQ is formed of p-type liquid crystals.

According to such a structure example, under the influence of an electric field formed between the pixel electrode PE and the common electrode CE during on conditions, the major axis of the liquid crystal molecules LM initially aligned in the second direction Y during off conditions rotates, as indicated by a continuous line in FIG. 10, in a plane substantially parallel to the X-Y plane. The liquid crystal molecules LM in a region surrounded by the pixel electrode PE, and primary common electrode CAL and secondary common electrode CBB rotate clockwise with respect to the second direction Y and are aligned to be directed toward the lower left in FIG. 10. The liquid crystal molecules LM in a region surrounded by the pixel electrode PE, and primary common electrode CAR and secondary common electrode CBB rotate counterclockwise with respect to the second direction Y and are aligned to be directed toward the lower right in FIG. 10. The liquid crystal molecules LM in a region surrounded by the pixel electrode PE, and primary common electrode CAL and secondary common electrode CBU rotate counterclockwise with respect to the second direction Y and are aligned to be directed toward the upper left in FIG. 10. The liquid crystal molecules LM in a region surrounded by the pixel electrode PE, and primary common electrode CAR and secondary common electrode CBU rotate clockwise with respect to the second direction Y and are aligned to be directed toward the upper right in FIG. 10.

In a state in which an electric field is formed between the pixel electrode PE and the common electrode CE in each pixel PX, more domains can be formed than in the example shown in FIG. 5, the viewing angle can be extended, and the alignment control force of liquid crystal molecules can be made stronger than in the example shown in FIG. 5.

According to the configuration of the pixel PX shown in FIG. 10, the liquid crystal layer LQ may be formed of n-type liquid crystals and also in this case, a sufficiently strong alignment control force of liquid crystal molecules can be obtained.

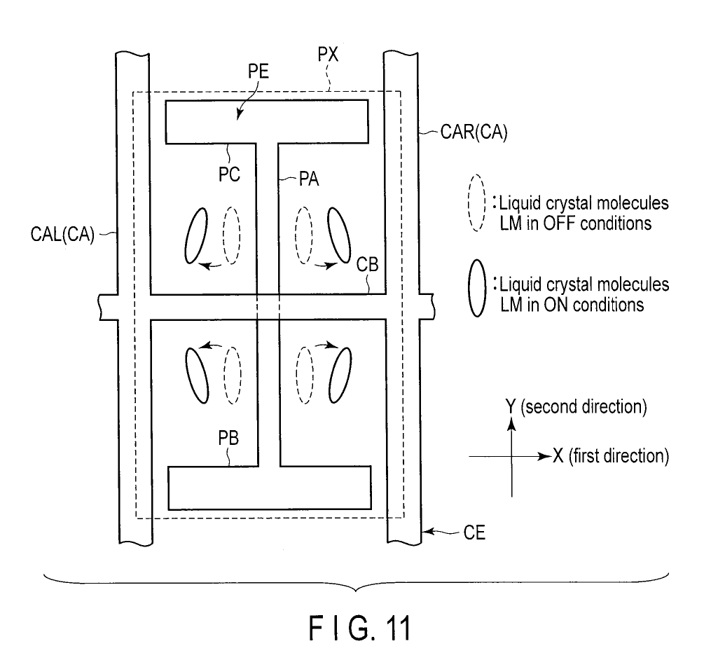

FIG. 11 is a plan view schematically showing still another structure example of one pixel PX when the liquid crystal display panel LPN shown in FIG. 4 is viewed from the countersubstrate side.

As shown in FIG. 11, a pixel electrode PE includes a primary pixel electrode PA, a first secondary pixel electrode PB, and a second secondary pixel electrode PC. The primary pixel electrode PA, the first secondary pixel electrode PB, and the second secondary pixel electrode PC are mutually electrically connected. In the present embodiment, the entire pixel electrode PE is included in an array substrate AR.

The primary pixel electrode PA has the major axis in a second direction Y. The first secondary pixel electrode PB and the second secondary pixel electrode PC extend in a first direction X. The second secondary pixel electrode PC is separated from the first secondary pixel electrode PB.

In the illustrated example, the pixel electrode PE is formed in an I-shape. More specifically, the primary pixel electrode PA is formed in a band shape linearly extending in the second direction Y in a substantial center of the pixel. The first secondary pixel electrode PB and the second secondary pixel electrode PC are each formed in a band shape linearly extending in the first direction X at the upper-side edge and the lower-side edge of the pixel PX respectively.

The first secondary pixel electrode PB and the second secondary pixel electrode PC may be arranged between upper and lower pixels. That is, the first secondary pixel electrode PB may be arranged extending over the boundary between the illustrated pixel PX and the lower-side pixel thereof (not shown) and the second secondary pixel electrode PC may be arranged extending over the boundary between the illustrated pixel PX and the upper-side pixel thereof (not shown).

The first secondary pixel electrode PB is coupled to one end of the primary pixel electrode PA and extends from the primary pixel electrode PA toward both sides thereof. The second secondary pixel electrode PC is coupled to the other end of the primary pixel electrode PA and extends from the primary pixel electrode PA toward both sides thereof. The first secondary pixel electrode PB and the second secondary pixel electrode PC are substantially orthogonal to the primary pixel electrode PA. The first secondary pixel electrode PB may be coupled to the primary pixel electrode PA by being shifted slightly to the other end from the one end and similarly, the second secondary pixel electrode PC may be coupled to the primary pixel electrode PA by being shifted slightly to the one end from the other end. The pixel electrode PE is electrically connected to the switching element (not shown) in, for example, the second secondary pixel electrode PC.

A common electrode CE includes a primary common electrode CA and a secondary common electrode CB. The primary common electrode CA and the secondary common electrode CB are mutually electrically connected. The common electrode CE described above is electrically insulated from the pixel electrode PE. In the present embodiment, at least a portion of the primary common electrode and secondary common electrode in the common electrode CE is included in a countersubstrate CT.

A pair of the primary common electrodes CA is positioned to sandwich the primary pixel electrode PA in the first direction X and has the major axis in the second direction Y. None of the primary common electrodes CA opposes the primary pixel electrode PA in the X-Y plane and substantially equal intervals are formed between each of the primary common electrodes CA and the primary pixel electrode PA.

The secondary common electrode CB extends in the first direction X. The secondary common electrode CB is arranged between the first secondary pixel electrode PB and the second secondary pixel electrode PC. None of the first secondary pixel electrode PB and the second secondary pixel electrode PC opposes the secondary common electrode CB in the X-Y plane and substantially equal intervals are formed between each of the first secondary pixel electrode PB and the second secondary pixel electrode PC and the secondary common electrode CB.

In the illustrated example, the primary common electrode CA is formed in a band shape linearly extending in the second direction Y. The secondary common electrode CB is formed in a band shape linearly extending in the first direction X. Two primary common electrodes CA run in parallel in the first direction X. To distinguish these primary common electrodes CA below, the primary common electrode on the left side in FIG. 11 will be called CAL and the primary common electrode on the right side in FIG. 11 will be called CAR. primaryPrimary common electrode CAL and primaryprimary common electrode CAR are each connected to the secondary common electrode CB.

primaryPrimary common electrode CAL and primaryprimary common electrode CAR are arranged between left and right pixels. That is, primary common electrode CAL is arranged extending over the boundary between the illustrated pixel PX and the pixel on the left side thereof (not shown) and primary common electrode CAR is arranged extending over the boundary between the illustrated pixel PX and the pixel on the right side thereof (not shown).

One primary pixel electrode PA is positioned between primary common electrode CAL and primary common electrode CAR adjacent to each other. Thus, primary common electrode CAL, the primary pixel electrode PA, and primary common electrode CAR are arranged in this order in the first direction X. That is, the primary pixel electrode PA and the primary common electrode CA are arranged alternately in the first direction X. The primary pixel electrode PA and primary common electrode CAL and primary common electrode CAR are arranged substantially in parallel. Moreover, the distance between primary common electrode CAL and the primary pixel electrode PA is substantially equal to the distance between primary common electrode CAR and the primary pixel electrode PA.

One secondary common electrode CB is positioned between the first secondary pixel electrode PB and the second secondary pixel electrode PC adjacent to each other. Thus, the first secondary pixel electrode PB, the secondary common electrode CB, and the second secondary pixel electrode PC are arranged in this order in the second direction Y. That is, the first secondary pixel electrode PB and the second secondary pixel electrode PC, and the secondary common electrode CB are arranged alternately in the second direction Y. The first secondary pixel electrode PB, the secondary common electrode CB, and the second secondary pixel electrode PC are arranged substantially in parallel. Moreover, the distance between the first secondary pixel electrode PB and the secondary common electrode CB is substantially equal to the distance between the second secondary pixel electrode PC and the secondary common electrode CB.

That is, in the illustrated example, four domains (mainly openings or transparent portions contributing to the display) partitioned by the pixel electrode PE and the common electrode CE in one pixel PX are formed. In the example shown here, the initial alignment direction of the liquid crystal molecules LM is a direction substantially parallel to the second direction Y, for example.

Though not described here in detail, at least one of the primary common electrodes CA may be opposed to the source wiring S extending substantially parallel to the primary common electrode CA (or in the second direction Y). Further, one of the first secondary pixel electrode PB, the second secondary pixel electrode PC, and the secondary common electrode CB may be opposed to the gate wiring G or the auxiliary capacitance wiring C extending substantially parallel to these electrodes (or in the first direction X).

The liquid crystal layer LQ is formed of p-type liquid crystals. In a state in which an electric field is formed between the pixel electrode PE and the common electrode CE in each pixel PX, more domains can be formed than in the example shown in FIG. 5, the viewing angle can be extended, and the alignment control force of liquid crystal molecules can be made stronger than that in the example shown in FIG. 5.

According to the configuration of the pixel PX shown in FIG. 11, the liquid crystal layer LQ may be formed of n-type liquid crystals and also in this case, a sufficiently strong alignment control force of liquid crystal molecules can be obtained.

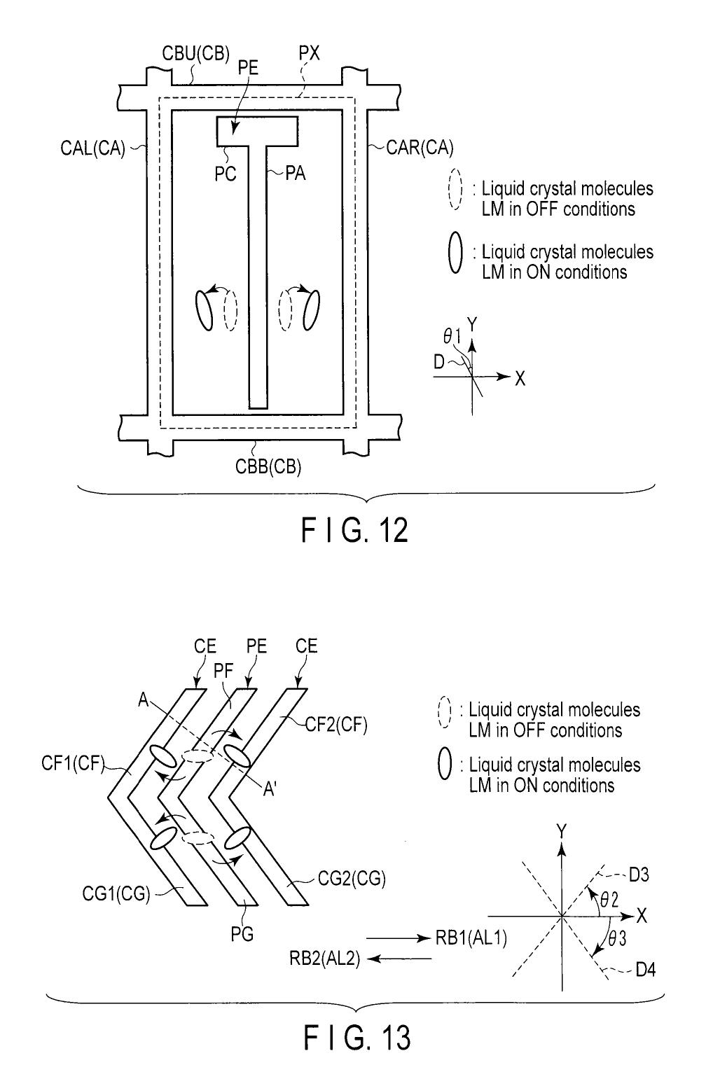

FIG. 12 is a plan view schematically showing still another structure example of one pixel PX when the liquid crystal display panel LPN shown in FIG. 4 is viewed from the countersubstrate side.

As shown in FIG. 12, the pixel PX is formed in the same manner as the pixel shown in FIG. 10 excluding a pixel electrode PE. The pixel electrode PE includes a primary pixel electrode PA and a secondary pixel electrode PC. The primary pixel electrode PA and the secondary pixel electrode PC are mutually electrically connected. In the present embodiment, the entire pixel electrode PE is provided in an array substrate AR.

The primary pixel electrode PA has a major axis in a second direction Y. The secondary pixel electrode PC extends in a first direction X. More specifically, the primary pixel electrode PA is formed in a band shape linearly extending in the second direction Y in a substantial center of the pixel. The secondary pixel electrode PC is formed in a band shape linearly extending in the first direction X at the upper-side edge of the pixel PX. The secondary pixel electrode PC may be arranged between upper and lower pixels. That is, the secondary pixel electrode PC may be arranged extending over the boundary between the illustrated pixel PX and the pixel on the upper side thereof (not shown).

The secondary pixel electrode PC is coupled to one end of the primary pixel electrode PA and extends from the primary pixel electrode PA toward both sides thereof. The secondary pixel electrode PC is substantially orthogonal to the primary pixel electrode PA. The secondary pixel electrode PC may be coupled to the primary pixel electrode PA by being shifted to the other end from the one end of the primary pixel electrode PA. The pixel electrode PE is, for example, electrically connected to the switching element (not shown) in the secondary pixel electrode PC. In the illustrated example, the pixel electrode PE is formed in a T-shape.

The pixel PX configured as described above can have two domains on the right side of the pixel PX (the upper right domain and the lower left domain in FIG. 10) and two domains on the left side of the pixel PX (the upper left domain and the lower right domain in FIG. 10).

The liquid crystal layer LQ is formed of n-type liquid crystals. In a state in which an electric field is formed between the pixel electrode PE and the common electrode CE in each pixel PX, more domains can be formed than in the example shown in FIG. 5, the viewing angle can be extended, and the alignment control force of liquid crystal molecules can be made stronger than in the example shown in FIG. 5. According to the configuration of the pixel PX shown in FIG. 12, the liquid crystal layer LQ may be formed of p-type liquid crystals and in such a case, a stronger alignment control force of liquid crystal molecules can be obtained.

FIG. 13 is a plan view schematically showing still another structure example of one pixel PX when the liquid crystal display panel LPN shown in FIG. 4 is viewed from the countersubstrate side.

As shown in FIG. 13, a pixel electrode PE includes a first primary pixel electrode PF and a second primary pixel electrode PG. The pixel electrode PE has a major axis in a second direction Y.

A more concrete description will be provided below. A case when the initial alignment direction corresponds to a first direction X, a first cross line direction counterclockwise crossing the initial alignment direction at an acute angle corresponds to a third direction D3, and a second cross line direction clockwise crossing the initial alignment direction at an acute angle corresponds to a fourth direction D4 is taken as an example.

The first primary pixel electrode PF has a band shape extending in the first cross line direction, that is, the third direction D3. The second primary pixel electrode PG has a band shape extending in the second cross line direction, that is, the fourth direction D4. The first primary pixel electrode PF and the second primary pixel electrode PG are connected by the respective ends. Thus, the pixel electrode PE is formed in a V-shape.

The common electrode CE includes a first primary common electrode CF and a second primary common electrode CG extending in a direction different from the first direction X and the second direction Y. The first primary common electrode CF has a band shape extending in the first cross line direction, that is, the third direction D3. The second primary common electrode CG has a band shape extending in the second cross line direction, that is, the fourth direction D4. The first primary common electrode CF and the second primary common electrode CG are connected by the respective ends. Thus, the common electrode CE is formed, like the pixel electrode PE, in a V-shape.

Two first primary common electrodes CF are illustrated in the first direction X. To distinguish these first primary common electrodes CF below, the first primary common electrode on the left side in FIG. 13 will be called CF1 and the first primary common electrode on the right side in FIG. 13 will be called CF2. Similarly, two second primary common electrodes CG run in the first direction X. To distinguish these two second primary common electrodes CG below, the second primary common electrode on the left side in FIG. 13 will be called CG1 and the second primary common electrode on the right side in FIG. 13 will be called CG2. The first primary common electrode CF1 and second primary common electrode CG1 are connected, and the first primary common electrode CF2 and second primary common electrode CG2 are connected. The first primary common electrodes CF1 and CF2, and the second primary common electrodes CG1 and CG2 are all electrically connected. That is, the common electrode CE is formed in a ctenidium shape.

One first primary pixel electrode PF is positioned between the adjacent first primary common electrodes CF1, CF2. That is, the first primary common electrodes CF1, CF2 are arranged on both sides across one first primary pixel electrode PF. Thus, first primary common electrode CF1, the first primary pixel electrode PF, and first primary common electrode CF2 are alternately arranged in the first direction X. The first primary pixel electrode PF and the first primary common electrodes CF1, CF2 are arranged in parallel with each other. The distance between first primary common electrode CF1 and the first primary pixel electrode PF is substantially equal to the distance between first primary common electrode CF2 and the first primary pixel electrode PF.

One second primary pixel electrode PG is positioned between the adjacent second primary common electrodes CG1, CG2. That is, the second primary common electrodes CG1, CG2 are arranged on both sides across one second primary pixel electrode PG. Thus, second primary common electrode CG1, the second primary pixel electrode PG, and second primary common electrode CG2 are alternately arranged in the first direction X. The second primary pixel electrode PG and the second primary common electrodes CG1, CG2 are arranged in parallel with each other. The distance between second primary common electrode CG1 and the second primary pixel electrode PG is substantially equal to the distance between second primary common electrode CG2 and the second primary pixel electrode PG.

The angle formed by the initial alignment direction with the first cross line direction, that is, an angle θ2 formed by the first direction X with the third direction D3, and the angle formed by the initial alignment direction with the second cross line direction, that is, an angle θ3 formed by the first direction X with the fourth direction D4 are preferably larger than 0° and smaller than 45°. Angle θ2 and angle θ3 may be the same angle. In such a case, if the length of the first primary pixel electrode PF and that of the second primary pixel electrode PG are the same, the pixel electrode PE has a linearly symmetrical shape with respect to a boundary between the first primary pixel electrode PF and the second primary pixel electrode PG in the first direction X. Also in this case, if the length of first primary common electrode CF1 and that of second primary common electrode CG1 are the same, and the length of first primary common electrode CF2 and that of second primary common electrode CG2 are the same, the common electrode CE has a linearly symmetrical shape with respect to a boundary between the first primary common electrode CF and the second primary common electrode CG in the first direction X.

The initial alignment direction is parallel to a line symmetry axis of the pixel electrode PT and that of the common electrode CE. By making the alignment treatment direction parallel to the symmetry axes of electrodes, as described above, the alignment of liquid crystal molecules is uniquely determined and, as described above, an occurrence of pulling can be inhibited because liquid crystal molecules are aligned symmetrically with respect to symmetry axes of electrodes when a voltage is applied.

The liquid crystal layer LQ is formed of p-type liquid crystals. In a state in which an electric field is formed between the pixel electrode PE and the common electrode CE in each pixel PX, more domains can be formed than those in the example shown in FIG. 5, the viewing angle can be extended, and the alignment control force of liquid crystal molecules can be made stronger than in that the example shown in FIG. 5.

The common electrode CE may further include an electrode. For example, as the pixel PX shown in FIGS. 5 and 6 is taken as an example, the common electrode CE may include, in addition to the primary common electrode CA included in the countersubstrate CT, a second primary common electrode (shield electrode) included in the array substrate AR and opposed to the primary common electrode CA (or opposed to the source wiring S). The second primary common electrode extends substantially in parallel with the primary common electrode CA and also is at the same potential as the primary common electrode CA. By providing such a second primary common electrode, an undesired electric field from the source wiring S can be screened out.

In addition to the primary common electrode CA included in the countersubstrate CT, the common electrode CE may include a secondary common electrode (shield electrode) included in the array substrate AR and opposed to the gate wiring G or the auxiliary capacitance wiring C. The secondary common electrode extends in a direction crossing the primary common electrode CA and also is at the same potential as the primary common electrode CA. By providing such a secondary common electrode, an undesired electric field from the gate wiring G or the auxiliary capacitance wiring C can be screened out. According to the configuration including such a second primary common electrode or a secondary common electrode, further degradation in display quality can be inhibited.

A liquid crystal display apparatus may be formed without the protection board 40. In such a case, the sensing substrate 30 (glass substrate 30S) can be used so that the sensing substrate 30 functions as a protection board.

What is claimed is:

1. A liquid crystal display apparatus, comprising:
a liquid crystal display panel including a first substrate including a pixel electrode, a second substrate including a common electrode, a liquid crystal layer held between the first substrate and the second substrate, a display area opposing with the first substrate, the second substrate and the liquid crystal layer, and a pixel provided in the display area, whose length in a first direction is shorter than length in a second direction orthogonal to the first direction, and formed of the pixel electrode and the common electrode, wherein the pixel electrode includes a primary pixel electrode including a major axis in the second direction and the common electrode includes a pair of primary common electrodes positioned to sandwich the primary pixel electrode in the first direction and including a major axis in the second direction;
a sensing substrate comprising an input area opposing the display area and configured to detect positional information of a location input into the input area; and
an adhesive opposed to the display area and the input area and positioned between the liquid crystal display panel and the sensing substrate to join the liquid crystal display panel and the sensing substrate.

2. The liquid crystal display apparatus according to claim 1, wherein the liquid crystal layer includes positive dielectric anisotropy.

3. The liquid crystal display apparatus according to claim 2, wherein
the first substrate includes a first alignment film covering the pixel electrode, the second substrate includes a second alignment film covering the common electrode, a first alignment treatment direction in which the first alignment film is treated for alignment is parallel to a symmetry axis of the pixel electrode, and a second alignment treatment direction in which the second alignment film is treated for alignment is parallel to the symmetry axis of the common electrode.

4. The liquid crystal display apparatus according to claim 3, wherein
the pixel electrode includes a secondary pixel electrode formed by extending in the first direction and
the common electrode includes a pair of secondary common electrodes positioned to sandwich the secondary pixel electrode in the second direction and formed by extending in the first direction.

5. The liquid crystal display apparatus according to claim 2, wherein
the pixel electrode includes a secondary pixel electrode formed by extending in the first direction and
the common electrode includes a pair of secondary common electrodes positioned to sandwich the secondary pixel electrode in the second direction and formed by extending in the first direction.

6. The liquid crystal display apparatus according to claim 1, wherein the first substrate includes a first alignment film covering the pixel electrode, the second substrate includes a second alignment film covering the common electrode, a first alignment treatment direction in which the first alignment film is treated for alignment is parallel to a symmetry axis of the pixel electrode, and a second alignment treatment direction in which the second alignment film is treated for alignment is parallel to the symmetry axis of the common electrode.

7. The liquid crystal display apparatus according to claim 6, wherein
the pixel electrode includes a secondary pixel electrode formed by extending in the first direction and
the common electrode includes a pair of secondary common electrodes positioned to sandwich the secondary pixel electrode in the second direction and formed by extending in the first direction.

8. The liquid crystal display apparatus according to claim 1, wherein the adhesive is formed of a material allowing visible light to pass through.

9. The liquid crystal display apparatus according to claim 1, wherein
the pixel electrode further includes a secondary pixel electrode extending in the first direction and is formed in a cross shape and
the common electrode further includes a pair of secondary common electrodes positioned to sandwich the primary pixel electrode in the second direction and formed by extending in the first direction.

10. The liquid crystal display apparatus according to claim 1, wherein
the pixel electrode further includes a first secondary pixel electrode coupled to one end of the primary pixel electrode and extending in the first direction and a second secondary pixel electrode coupled to the other end of the primary pixel electrode and extending in the first direction, and is formed in an I-shape and
the common electrode further includes a secondary common electrode positioned between the first secondary pixel electrode and the second secondary pixel electrode and formed by extending in the first direction.

11. The liquid crystal display apparatus according to claim 1, wherein
the pixel electrode further includes a secondary pixel electrode coupled to one end of the primary pixel electrode and extending in the first direction and is formed in a T-shape and
the common electrode further includes a pair of secondary common electrodes positioned to sandwich the primary pixel electrode in the second direction and formed by extending in the first direction.

12. A liquid crystal display apparatus, comprising:
a liquid crystal display panel including a first substrate comprising a pixel electrode, a second substrate including a common electrode, a liquid crystal layer held between the first substrate and the second substrate, a display area opposing the first substrate, the second substrate and the liquid crystal layer, and a pixel provided in the display area, whose length in a first direction is shorter than length in a second direction orthogonal to the first direction, and formed of the pixel electrode and the common electrode, wherein the pixel electrode includes a primary pixel electrode including a major axis in the second direction and the common electrode includes a pair of primary common electrodes positioned to sandwich the primary pixel electrode in the first direction and including the major axis in the second direction;
a sensing substrate comprising an input area opposing the display area and configured to detect positional information of a location input into the input area; and
an adhesive opposed to the display area and the input area and positioned between the liquid crystal display panel and the sensing substrate to join the liquid crystal display panel and the sensing substrate, wherein
the liquid crystal layer includes negative dielectric anisotropy,
the pixel electrode includes a secondary pixel electrode formed by extending in the first direction, and
the common electrode includes a pair of secondary common electrodes positioned to sandwich the secondary pixel electrode in the second direction and formed by extending in the first direction.

13. The liquid crystal display apparatus according to claim 12, wherein the primary pixel electrode and the secondary pixel electrode cross in a cross shape,
the common electrode includes a secondary common electrode arranged in parallel with the secondary pixel electrode, and
the pixel electrode is surrounded by the primary common electrode and the secondary common electrode.

14. A liquid crystal display apparatus, comprising:
a liquid crystal display panel including a first substrate including a pixel electrode including a primary pixel electrode and a secondary pixel electrode orthogonal to and connected to the primary pixel electrode and a first alignment film covering the pixel electrode and initially treated for alignment in parallel with the primary pixel electrode, a second substrate including a common electrode comprising a primary common electrode arranged in parallel with the primary pixel electrode and a secondary common electrode orthogonal to and connected to the primary common electrode and a second alignment film covering the common electrode and initially treated for alignment in parallel with the primary common electrode, and a liquid crystal layer held between the first substrate and the second substrate, including liquid crystal molecules of positive dielectric anisotropy, and including a cell gap smaller than an interval between the primary pixel electrode and the primary common electrode;
a sensing substrate including an input area opposing a display area opposing with the first substrate, the second substrate and the liquid crystal layer configured to detect positional information of a location input into the input area;
a first adhesive opposed to the display area and the input area and positioned between the liquid crystal display panel and the sensing substrate to join the liquid crystal display panel and the sensing substrate;
a protection board opposed to the sensing substrate; and
a second adhesive opposed to the display area and the input area and positioned between the sensing substrate and the protection board to join the sensing substrate and the protection board.

15. The liquid crystal display apparatus according to claim 14, wherein
the first substrate includes a gate wiring extending in a first direction and a source wiring extending in a second direction orthogonal to the first direction,
the primary common electrode is arranged opposed to the source wiring, and
the secondary common electrode is arranged opposed to the gate wiring.

16. The liquid crystal display apparatus according to claim 15, wherein the primary pixel electrode and the secondary pixel electrode cross in a cross shape.

17. The liquid crystal display apparatus according to claim 16, wherein
the first adhesive includes a refractive index between a refractive index of the second substrate and a refractive index of the sensing substrate and
the second adhesive includes a refractive index between the refractive index of the sensing substrate and a refractive index of the protection board.

18. The liquid crystal display apparatus according to claim 17, wherein an initial alignment direction of the first alignment film and the initial alignment direction of the second alignment film are a same direction.

19. The liquid crystal display apparatus according to claim 14, wherein the first adhesive includes a refractive index between a refractive index of the second substrate and a refractive index of the sensing substrate and
the second adhesive includes a refractive index between the refractive index of the sensing substrate and a refractive index of the protection board.

20. The liquid crystal display apparatus according to claim 14, wherein an initial alignment direction of the first alignment film and the initial alignment direction of the second alignment film are a same direction.
